(19) United States
(12) Patent Application Publication
(10) Pub. No.: US 2024/0400417 A1
(43) Pub. Date: Dec. 5, 2024

(54) SYSTEMS AND METHODS FOR TREATMENT OF CONTAMINATED FOAM STREAMS USING SURFACTANTS

(71) Applicant: Battelle Memorial Institute, Columbus, OH (US)

(72) Inventors: Slawomir WINECKI, Dublin, OH (US); Devin DICKSON, Columbus, OH (US); Chris HALL, Fort Myers, FL (US); Stephanie NAPIERALSKI, Columbus, OH (US); Philip KESTER, Midland, MI (US); Emma BRACKMAN, Columbus, OH (US); Leonardo CHIQUES, Cape Coral, FL (US); Hong Be TRUONG, Lewis Center, OH (US)

(73) Assignee: BATELLE MEMORIAL INSTITUTE, Columbus, OH (US)

(21) Appl. No.: 18/650,868

(22) Filed: Apr. 30, 2024

Related U.S. Application Data
(63) Continuation-in-part of application No. 18/642,499, filed on Apr. 22, 2024.
(60) Provisional application No. 63/587,094, filed on Sep. 30, 2023.
(60) Provisional application No. 63/587,096, filed on Sep. 30, 2023.
(60) Provisional application No. 63/587,097, filed on Sep. 30, 2023.
(60) Provisional application No. 63/587,095, filed on Sep. 30, 2023.
(60) Provisional application No. 63/470,631, filed on Jun. 2, 2023.

(51) Int. Cl. C02F 1/24; C02F 1/28; C02F 1/54; C02F 101/36

(52) U.S. Cl. CPC C02F 1/24; C02F 1/283; C02F 1/547; C02F 2101/36; C02F 2301/08

(57) ABSTRACT

A method for using foam fractionation to remove a PFAS contaminant from a water source is disclosed herein. The method includes providing a feed stream to an inlet of an active column. The method also includes introducing the feed stream into an interior of the active column. The method also includes flowing gas through an active column into the interior of the active column. The method also include rising gas through the feed stream in the interior of the active column to form gas bubbles in the feed stream. The method also includes forming a foam layer. The method also includes, in instances where insufficient foam is generated due to depletion of surfactant in the earlier columns, adding additional surfactant through ports located in various columns throughout the system to ensure the presence of sufficient surfactant in all columns and optimize the volume of foam produced in each stage.

### CROSS-REFERENCE TO RELATED PATENT APPLICATIONS

This application claims priority to U.S. Appl. Ser. No. 63/587,094, filed Sep. 30, 2023, entitled “Foam Fractionation Processes Using Surfactants,” and to U.S. Appl. Ser. No. 63/587,096, filed Sep. 30, 2023, entitled “Systems And Methods For The Removal Of Short-Chain PFAS During Foam Fractionation,” which patent applications are commonly owned by the owner of the present invention. This application claims priority to U.S. patent application Ser. No. 18/642,499, filed Apr. 22, 2024, entitled “Systems and Methods for Utilizing Foam Fractionation to Separate and Eliminate PFAS,” which claims priority to U.S. Patent Appl. Ser. No. 63/470,631, filed Jun. 2, 2023, entitled “Systems and Methods for Utilizing Foam Fractionation to Separate and Eliminate PFAS,” and U.S. Patent Appl. Ser. No. 63/587,097, filed Sep. 30, 2023, entitled “Systems and Methods for Flexible Foam Fractionation,” and U.S. Patent Appl. Ser. No. 63/587,095, filed Sep. 30, 2023, entitled “Systems and Methods for Foam Draining Using Angled Foam Fractionation Columns,” which patent applications are commonly owned by the owner of the present invention. These patent applications are incorporated herein in its entirety.

### TECHNICAL FIELD

The present disclosure relates to an improved treatment systems and methods for removing, isolating, or separating a substance from water or aqueous solutions. In particular, the present disclosure relates to the separation of perfluoroalkyl or polyfluoroalkyl substances from water. Embodiments of the present disclosure can also be applied can also be applied to the removal of non-organic materials or contaminants from all types of contaminated water sources.

Moreover, the system, method, and related apparatuses of the present disclosure relates to the removal of contaminants from a contaminated water source through the use of foam fractionation processes. More particularly, aspects and embodiments of the present disclosure disclosed herein are related to a sustainable and efficient removal and elimination of perfluoroalkyl and polyfluoroalkyl substances (PFAS) from water using continuous, multistage foam fractionation processes. In some embodiments, aspects and embodiments of the present disclosure disclosed herein are related to a sustainable and efficient removal and elimination of perfluoroalkyl and polyfluoroalkyl substances (PFAS) from water using foam fractionation processes with flexibility to meet required flexibility to meet output requirements in terms of concentration, flow, and combinations thereof.

### STATEMENT OF FEDERALLY FUNDED RESEARCH

None.

### BACKGROUND

Perfluoroalkyl and polyfluoroalkyl materials (PFAS) are a class of compounds that have been used in the manufacture of consumer and industrial chemicals. The PFAS chemical class comprises thousands of human-made chemicals. In fact, current estimates by the Organization for Economic Cooperation and Development (“OECD”) predict that there are over 4,700 distinct PFAS chemicals. The most commonly utilized PFAS are perfluorooctanoic acid (“PFOA”) and perfluorooctane sulfonic acid (“PFOS”).

The feature that makes all of these chemicals fall within the class of PFAS is a particular kind of bond present within the chemical. Specifically, each of these chemicals has at least one atom of carbon bound to a fluorine atom (a C—F bond). This short polar-covalent chemical bond makes these substances extremely strong. Most PFAS-including the once commonly utilized chemicals of PFOA and PFOS-break down exceptionally slowly and remain in the environment, leading to PFAS being noted as “forever chemicals.”

For a longstanding period of time, the public was unaware of the toxicity of PFAS. In stark contrast to the environmental hazard that PFAS are currently viewed as posing, PFAS were considered a useful addition to the commercial industry when first introduced in the 1940s. PFAS were durable, resistant to extreme temperatures, hydrophobic, and oleophobic. Because of these qualities, PFAS were quickly incorporated into a variety of products: microwavable food packaging, stain-resistant carpet coating, Teflon cookware, and firefighting foam.

Mass amounts of these products were manufactured and subsequently stored or disposed of worldwide. In particular, aqueous film-forming foams (AFFF) has been used extensively as a fire suppressant. In fact, AFFF was a longstanding primary fire suppressant utilized by global military fire training bases. AFFF works by covering a fuel spill, cooling surfaces, and preventing re-ignition. After product use, PFAS would disperse into the ecosystem. In particular, the AFFF, when used for training firefighters, military use, and at-home fire protection, were intentionally routed to run-off to the nearest water system. These practices resulted in PFAS deposits into soil, rivers, lakes, well water and drinking water.

PFAS has been proven toxic when introduced into the human body. PFAS introduced into the body through ingestion of drinking contaminated water will not decompose and instead will bioaccumulate. The bioaccumulation results in PFAS entering the bloodstream, which can result in long-term, adverse health effects in humans, such as cancer, and developmental health effects, such as low birth weight.

Moreover, beyond human effects, PFAS can contaminate animal bloodstreams as well. PFAS has been found in mammals' milk and animal offspring, leading to dairy farm shutdowns. The consumption of contaminated milk, from either humans or other mammals exposed to PFAS, by babies and young children was also shown to lead to negative developmental health effects.

In 2016, the U.S. Environmental Protection Agency (EPA) issued the following Health Alerts (HA) for PFOA and PFOS: the sum of the individual components and concentrations for PFOS and PFOA, respectively, is 0.07. mu.g/L. In response to the increasing harms being linked to PFAS, the United States Agency for Toxic Substances and Disease Registry conducted a study on the health effects of PFAS and developed estimate minimal risk levels for common PFAS. The study revealed that even low concentrations of PFAS may be associated with adverse health outcomes. In particular, the study noted that drinking water containing concentrations for PFOA of 78 parts per trillion (ppt) for adults and 21 ppt for children, and for PFOS of 52 ppt for adults and 14 ppt for children, would lead to health problems.

While the harms associated with PFAS are now recognized, addressing and correcting the problems associated with PFAS remains a difficulty-especially when attempting to handle the decontamination of PFAS-contaminated sources in large quantities. Because of PFAS's extreme stability, based on the above-mentioned carbon-fluorine bonds, the PFAS contaminants are highly resistant to degradation. Accordingly, to decontaminate exposed water and aqueous solutions, processes must involve targeted removal of PFAS.

Most of the available conventional water treatment systems and methods of removing PFAS from water have proven ineffective. Specifically, conventional systems and methods that attempt to remove PFAS also include biological treatment, air stripping, reverse osmosis and advanced oxidation. All of these conventional techniques are inefficient and often are extremely expensive in practice.

Foam fractionation is a chemical process in which hydrophobic molecules are preferentially separated from a liquid solution using rising columns of air bubbles, with a resulting foam layer on top of the solution trapping the hydrophobic molecule. In general two mechanisms provide for effective removal of molecules from a solution, first a target molecule adsorbs to a bubble surface, and then the bubbles travel up a column and form a foam layer on top which can be collected and disposed of.

Foam fractionation predominantly removes surfactant contaminant molecules (molecules that have polar and non-polar ends). At the air-water interface of the bubbles the surfactant molecules orientate themselves so that the non-polar hydrophobic end of the surfactant molecules is in air and the polar hydrophilic end of the molecule is in water. As the bubbles rise to the top of the fractionating column they remove the contaminants and settle at the top of the column as a foam.

Many organic substances can be removed by foam fractionation and larger biological material, such as algae, bacteria and viruses can also be removed. Particles present in the water can also be removed. Inorganic material can also be removed based on the formation of a bond between the inorganic material with the organic matter or a surfactant in the water. For example, calcium carbonate and calcium phosphate complexes can collect organic matter in the water forming micro-flocs that can get trapped in the film surrounding the air bubbles. Metal ions can also form ligands with organic molecules, and glycoproteins have a high affinity for trace metals and therefore facilitate removal of metal ion species from water.

Efficient contaminant removal is complex and depends on many factors including air to water ratio; column height; air bubble diameter; air/water contact time; air bubble flow rate; foaming agent; foam wetness; downward water flow rate; foam stability; and collision speed between the water and the rising gas. Foam stability is also an important factor and can be defined as the resistance to water and contaminant drainage from the foam, without foam rupturing. The foam must be stable enough to be removed from the fractionating column, without leaching of the contaminant molecules into the water.

Efforts to use foam fractionation for the removal of PFAS contaminants often relies on batch processes, which can prove difficult to both scale and to operate. When attempting to scale batch processes for using foam fractionation to remove PFAS from water and aqueous solutions, operators are necessary to control feedback and intervention in the process. Moreover, those using foam fractionation systems are in need of a flexible system that can meet their output requirements in terms of concentration, flow, or a combination thereof.

Accordingly, there is a need to develop a PFAS removal system and method that can extract, separate, or isolate PFAS from water or aqueous solutions in a manner that is effective, low-cost, scalable, and safe to operate. There is also a need to develop a mobile system that can be controlled in terms of flow capacity and concentration capability.

### SUMMARY OF THE INVENTION

The present invention is directed to a method and system for using a continuous, multistage foam fractionation process to remove PFAS from a contaminated water source. In some embodiments, the removed PFAS may then be destroyed through the use of a supercritical water oxidation method. In some embodiments, the method and system may further involve the addition of a surfactant additive to enhance the removal of particular PFAS compounds. From this, in some embodiments, the method and system may be utilized to remove PFAS compounds from highly contaminated streams.

In general, in one embodiment, the disclosure features a method for using foam fractionation to remove a PFAS contaminant from a water source. The method can include providing a feed stream to an inlet of an active column, where the feed stream comprises the PFAS contaminant and water. The method can also include introducing the feed stream into an interior of the active column. The method can also include flowing gas through an active column into the interior of the active column. The method can also include, as a result of the flowing of the gas into the interior of the active column, rising gas through the feed stream in the interior of the active column to form gas bubbles in the feed stream. The method can also include, as a result of the gas bubbles in the feed stream, forming a foam layer. The foam layer can be situated atop the feed stream in the interior of the active column. The foam layer can include at least a part of the PFAS contaminant. After the foam layer is formed, the interior of the active column can include the foam layer and a purified stream. The method can also include, in instances where insufficient foam is generated due to depletion of surfactant in the earlier columns, adding additional surfactant through ports located in various columns throughout the system to ensure the presence of sufficient surfactant in all columns and optimize the volume of foam produced in each stage.

The method can also include passing the purified stream into a next column, where the next column operates as the active column and the purified stream operates as the feed stream. The method can also include continuously repeating steps until the feed stream becomes a cleaned stream, where a cleaned stream comprises water and at or below a final concentration of the PFAS contaminant. The method can also include collecting the foam layer. The method can also include disposing of the foam layer.

In general, in another embodiment, the invention features a system for using foam fractionation to remove a PFAS contaminant from a water source. The system can include a feed stream comprising water, one or more PFAS contaminants, and an effective amount of a surfactant, where the surfactant interacts with the PFAS contaminant to form a complexing agent facilitating the removal of light PFAS. The system can include a gas, operable to induce a plurality of bubbles in the feed stream and create a foam layer at and above the interface of the feed stream, where the foam layer comprises the complexing agent and the one or more contaminants. The system can include a plurality of columns, where each column includes a feed inlet configured to receive the feed stream and a gas inlet configured to allow the gas to enter. Each column can be operably configured to separate the contaminants into a foam layer and a purified stream. Each column can include a foam outlet and a feed outlet configured to discharge the purified stream. Each column can be coupled to one or more other columns allowing continuous passage of the feed stream. The plurality of columns can include a plurality of ports for surfactant addition, where the plurality of ports are located throughout various columns in the plurality of columns to optimize the volume of foam produced in each stage and ensure sufficient surfactant presence. The plurality of ports for adding surfactants can be installed in a configuration enabling the addition of surfactants at different columns, such as every other column.

### BRIEF DESCRIPTION OF THE DRAWINGS

Other advantages of the present invention will be apparent from the following detailed description of the invention in conjunction with embodiments as illustrated in the accompanying drawings, in which:

FIG. 1 depicts a continuous foam fractionation system for use with water contaminated with PFAS, in accordance with certain embodiments of the present disclosure.

FIG. 2 depicts a process for removing and disposing of concentrated PFAS using a continuous foam fractionation system for use with water contaminated with PFAS, in accordance with certain embodiments of the present disclosure.

FIG. 3 depicts a supercritical water oxidation method for use in a process for removing and disposing of concentrated PFAS using a continuous foam fractionation system for use with water contaminated with PFAS, in accordance with certain embodiments of the present disclosure.

FIG. 4 depicts a block diagram of a method for using a continuous foam fractionation system to treat water contaminated with PFAS, in accordance with certain embodiments of the present disclosure.

FIG. 5 depicts a diagram of a modular system that allows for flexibility in flow and concentration based on capabilities and needs of a system, in accordance with certain embodiments of the present disclosure.

FIG. 6 depicts a diagram of a system that allows for flow routing using a plurality of inlet ports, in accordance with certain embodiments of the present disclosure.

FIG. 7 depicts a diagram demonstrating the ability to increase concentration in system that allows for the modular components in a system flexible foam fractionation to be removed from a housing, in accordance with certain embodiments of the present disclosure.

FIG. 8 depicts a foam fractionation system with ports for adding additional surfactant, in accordance with certain embodiments of the present disclosure.

FIG. 9 depicts an angled foam fractionation column, in accordance with certain embodiments of the present disclosure.

FIG. 10 depicts a foam fractionation system with ports for adding additional surfactant, in accordance with certain embodiments of the present disclosure.

FIG. 11 depicts an illustration of a dedicated short chain removal unit within a foam fractionation system, in accordance with certain embodiments of the present disclosure.

FIG. 12 depicts an illustration of a dedicated short-chain PFAS removal unit separate from the long-chain PFAS removal units, in accordance with certain embodiments of the present disclosure.

### DETAILED DESCRIPTION OF THE INVENTION

The present disclosure relates to system and methods for using foam fractionation to remove a PFAS contaminant from a water source. In accordance with one or more embodiments, the systems and methods disclosed herein relate to the separation, concentration, and destruction of PFAS from a source of water that is contaminated with PFAS.

As discussed above, the man-made PFAS chemical compounds are highly stable because of the mentioned carbon-fluorine bonds, which are longstanding and do not readily decompose in the environment. Additionally, PFAS-especially PFAS from products in which it was used as a repellant and protective coating-has cumulated in various water supplies. Even with largescale efforts to phase out the use of PFAS compounds, elevated levels of the “forever chemicals” remain present throughout the environment. PFAS may be found in areas near prevalent uses of prior PFAS products (such as near fire training facilities) and in locations where PFAS has migrated through water and air.

In some non-limiting embodiments, prevalent PFAS, such as PFOS and PFOA, may be removed from water using the methods and systems disclosed herein.

Additionally, based on the EPA's revised guidelines published in May 2016 and recent regulation efforts, water distribution and filtering facilities are now aware of the limits of a combined lifetime exposure of 70 parts per trillion (ppt) for PFOS and PFOA. In some cases, the systems described herein can maintain a concentration of PFAS in treated water to be below the regulated and advised levels.

In certain embodiments, the overall process, can be characterized by taking a PFAS-concentration of at least 100 ppm PFAS by weight (in some embodiments at least 500 ppm or at least 1000 ppm PFAS) to 1 ppm or less, or 0.1 ppm or less, or 0.01 ppm or less. Alternatively, by taking a PFOA-concentration of at least 100 ppm PFOA by weight (in some embodiments at least 500 ppm or at least 1000 ppm PFOA) to 1 ppm or less, or 0.1 ppm or less, or 0.01 ppm or less, or 1.0 ppb or less, or 0.1 ppb or less, or 0.01 ppb or less PFOA; in some embodiments in the range of 1 ppm to 5 ppt (part per trillion) PFOA. Alternatively, by taking a PFOS-concentration of at least 100 ppm PFOS by weight (in some embodiments at least 500 ppm or at least 1000 ppm PFOS) to 1 ppm or less, or 0.1 ppm or less, or 0.01 ppm or less, or 1.0 ppb or less, or 0.1 ppb or less, or 0.01ppb or less PFOS; in some embodiments in the range of 1 ppm to 5 ppt (part per trillion) PFOS. The process can also be characterized by the same levels of destruction beginning with a PFAS concentration of less than 100 ppm. In some embodiments, PFAS-contaminated water comprising at least 1000 ppt of at least one (or at least 3 or at least 4 or at least 5 or at least 6) compound selected from the group consisting of PFHxA (perfluorohexanoic acid), PFHpA (perfluoroheptanoic acid), PFOA, PFBS (perfluorobutane sulfonate), PFHxS (perfluorohexane sulfonate), PFHpS (perfluoroheptane sulfonate), and PFOS and combinations thereof, treated by the process is (are) reduced by at least 2 (or at least 3 or at least 4 or at least 5) orders of magnitude. In some embodiments, PFAS-contaminated water comprising at least 100 ppt of at least one (or at least 3 or at least 4 or at least 5 or at least 6) compound selected from the group consisting of PFBA (perfluorobutanoic acid), PFPeA (perfluoropentanoic acid), PFHxA, PFHpA, PFOA, 6:2 FTS (6:2fluorotelomer sulfonate), and 8:2 FTS (8:2 fluorotelomer sulfonate) and combinations thereof, treated by the process is (are) reduced by at least 2 (or at least 3 or at least 4 or at least 5) orders of magnitude and/or reduced to 5 ppt (or 1 ppt) or less.

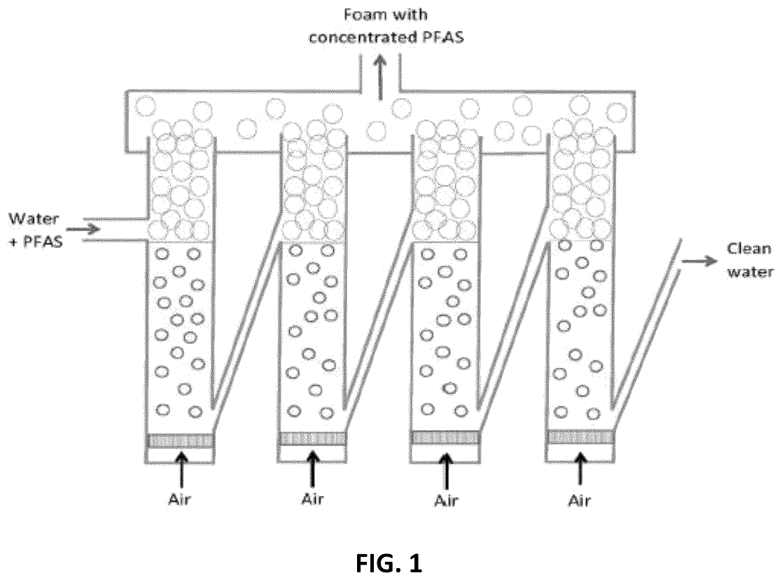

FIG. 1 depicts a continuous foam fractionation system for use with water contaminated with PFAS, in accordance with certain embodiments of the present disclosure.

In some embodiments, separation of PFAS from a source of contaminated water may be achieved using foam fractionation. In such an embodiment, and in accordance with the system shown in FIG. 1, hydrophobic molecules-including the PFAS molecules contaminating the water-can be removed and extracted as a foam. Specifically, in such an embodiment, air can be introduced to a container to produce gas bubbles. In some embodiments, the container is a column, a tank, a vessel, a tube, or combinations thereof. In embodiments of the present disclosure, multiples containers are utilized in order to allow for continuous foam fractionation. In the embodiment of FIG. 1, the configuration allows for air to rise through of contaminated water. In such an embodiment, as air rises through the contaminated water bubbles may be formed. Such bubbles, in this embodiment and as depicted in FIG. 1, allow for the removal of hydrophobic molecules. In such an embodiment, the bubbles will have an air-water interface with a large surface area. The groups on PFAS molecules adsorb to the bubbles of the foam and form a surface layer enriched in PFAS that can subsequently be removed.

In some embodiments, the gas introduced to the system of FIG. 1 may be compressed air or nitrogen. In other embodiments, the gas introduced to the system can be an oxidizing gas, such as ozone.

In some embodiments, the gas is introduced from the base of the container that houses the contaminated water. Further, in some embodiments, the pressure of the container can operate to facilitate the movement of the gas bubbles through the contaminated water and help to form a foam layer.

FIG. 1 shows that the initial inlet in the fractionation column can operate as a point of entrance for a feed stream, where the feed stream contains both water and the PFAS contaminant. As further shown in FIG. 1, the introduction of air from the base of the fractionation column can rise to cause bubbles to propel through the feed in the container and ultimately cause the collection of foam concentrated with the PFAS contaminant at the top of the system of FIG. 1.

FIG. 1 also shown that the feed outlet in one fractionation column can be operatively connected to allow the feed stream to immediately feed into the next fractionation column. In some embodiments, the feed outlet is placed at an upper region of each fractionation column.

Further, as depicted in FIG. 1, in some embodiments, at the top of each fractionation column, there can exist an outlet that allows the feed stream to flow from one foam fractionation column to the next. In some embodiments, the system can include a series of fractionation columns, which can be used to increasingly purify the water by the continuous foam fractionation. In such an embodiment, the PFAS in feed stream will be repeatedly gathered as the feed stream passes through each column. In such an example, the feed stream entering the system will have an initial concentration of PFAS. Following, after the feed stream passes through the first foam fractionation column, the feed stream, which now may be referred to as the purified stream, will have a lower concentration of PFAS. In such an embodiment, this is because many of the PFAS molecules have been removed and isolated in the foam that rests atop the purified stream. Thus, as mentioned, in such embodiments, the concentration of PFAS in the purified stream exiting each column will be lower than that of the feed stream that initially entered the column.

Further, in some embodiments, the system can discharge the feed stream, which can then be referred to as the cleaned stream, once it has a sufficient amount of the PFAS removed. For example, in some embodiments, the cleaned stream can be removed from the system when there is less than 70 parts per trillion (i.e., below the regulatory recommended amount from the EPA's guidance) of PFAS remaining in the cleaned stream. In certain embodiments, the final amount of PFAS left in the cleaned stream may be 1 ppm or less, or 0.1 ppm or less, 0.01 ppm or less, 0.001ppm (1 ppb) or less, 0.0001 ppm (0.1 ppb) or less, 0.00001 ppm (0.01 ppb) or less, or 0.000001ppm (0.001 ppb or 1 ppt) or less.

As is also shown in FIG. 1, the system can also include a final outlet that can discharge the feed stream. In some embodiments, the cleaned stream, which will include primarily water or aqueous solution, once discharged from the final outlet of the system may be released back into the environment. In such an embodiment, the cleaned stream can contain minimal amounts of PFAS, such that the concentration of PFAS in the cleaned stream does not pose a risk to humans, animal, or wildlife that the water source may reach once back in the environment.

In the embodiment depicted in FIG. 1, the process can be a fully continuous, multistage process. In such an embodiment, the process can have a high throughput. Further, such an embodiment presents the benefit of having an unlimited scalability, where the process can be used on a small scale for testing small portions of potentially contaminated water, or on a large scale where vast amounts of contaminated water may be run through the continuously run system. Because of the continuous foam fractionation, the system depicted in FIG. 1 may be easily operated without the need for excessive interaction and invention from operators of the system.

In some embodiments, the system as depicted in FIG. 1 may include a feed stream that has an effective amount of a surfactant added therein. In such an embodiment, the surfactant can interact with the PFAS contaminant to create a complexing agent. Accordingly, such a system may be utilized to effective remove light PFAS from a contaminated water source. For example, light PFAS, referring to PFAS with C-4 or less, which may not rise in a standard foam fractionation process may be removed in an enhanced manner through the use of such surfactant. Specifically, in such an embodiment, the light PFAS foam layer comprises the complexing agent. Surfactants may be introduced at different locations. For example, in some embodiments, the surfactants may be introduced prior to the feed stream entering the column. In other embodiments, the surfactants may be introduced to a purified stream in a series of active columns. Moreover, in some embodiments, the system may include multiple surfactant addition points, where the surfactants are added to the feed stream, the purified stream, or combinations thereof.

In some embodiments, where the later columns in the system generate an insufficient amount of foam due to depletion of surfactant from the feed stream in the earlier columns, the system and process can further include adding additional surfactant into various columns throughout the system, which ensures that sufficient surfactant is present in all columns of the system. In such an embodiment, there can be a significant benefit of allowing for the addition of more columns to the system. Accordingly, in some embodiment, the foam fractionation system include ports for surfactant addition throughout the foam fractionation columns to achieve the target separation.

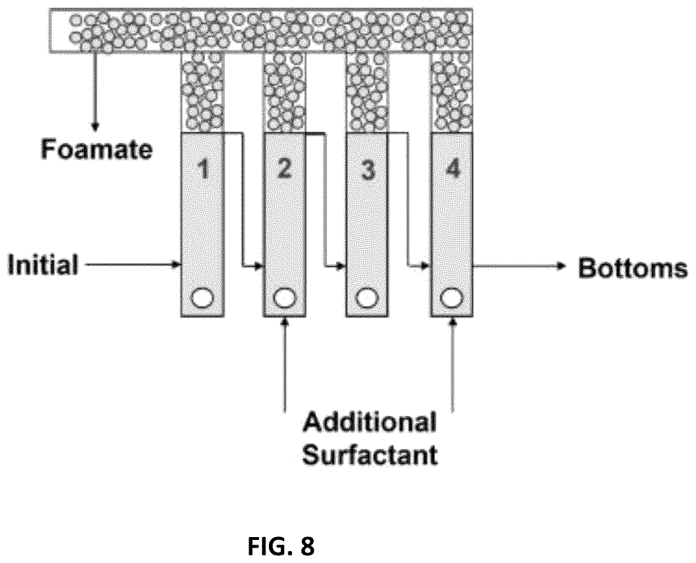

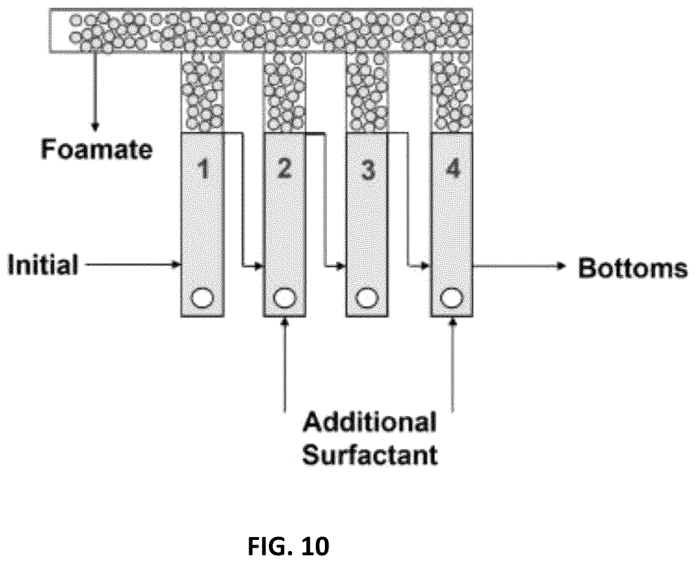

As shown in FIGS. 8 and 10, which depicts a foam fractionation system with ports for adding additional surfactant, in accordance with certain embodiments of the present disclosure, the ports may be installed into a certain number of columns. For example, and as shown in FIG. 8, the ports for adding surfactant may be added into every other column. The addition of surfactants at the ports can allow for the volume of foam produced can be optimized in each stage. In some embodiments, different surfactant amounts and/or types may be injected at different points., FIG. 10 depicts a foam fractionation system with ports for adding additional surfactant, in accordance with certain embodiments of the present disclosure.

In some embodiments of the system, once a contaminated water source is identified, the contaminated water source is then fed to the system in a feed stream, as is shown in FIG. 1 and discussed above. Further, in this embodiment, the feed stream once in a foam fractionation column may be super-saturated with air. In such an example, the air can be pumped, injected, or flowed through the contaminated water in the foam fractionation column. Because the feed stream is super saturated, the air bubbles rise through the water, while proteins, amphipathic species, and contaminants adsorb to the surface of the air bubbles. In such an embodiment, the air bubbles can then collects as a foam on top of the feed stream in the foam fractionation column.

In some embodiments, the system of FIG. 1 may be utilized with pH and/or ionic strength adjustments. In such an embodiment, particular additives may be added to the feed stream entering the system in order to control the system at a particular operating pH. In certain embodiments, being used either in conjunction with the pH control additives or independently, particular additives may be added to the feed stream entering the system in order to control the system at a particular operating ionic strength. In such an example, the system of FIG. 1 may be used not only with ground water from PFAS contaminated locations, but also with highly contaminated streams containing large amounts of inorganics in addition to PFAS.

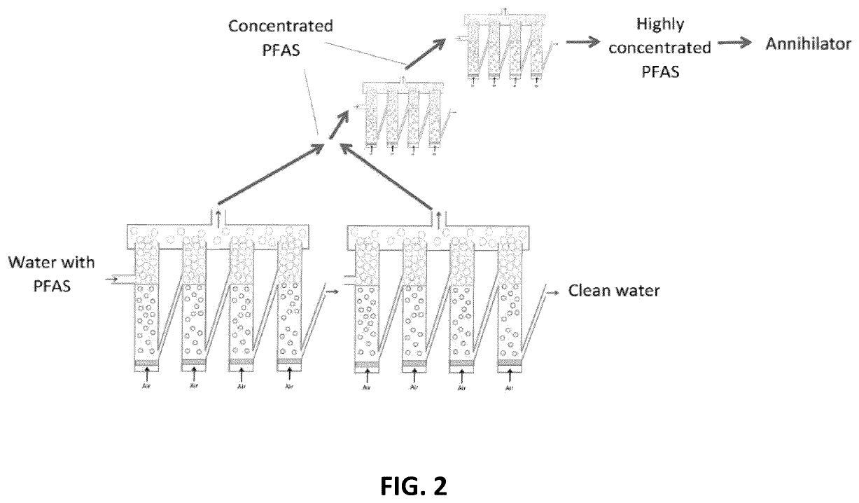

FIG. 2 depicts a process for removing and disposing of concentrated PFAS using a continuous foam fractionation system for use with water contaminated with PFAS, in accordance with certain embodiments of the present disclosure. In such embodiments as shown in FIG. 2 the foam collected from the initial system as shown in FIG. 1 may be further run through continuous fractionation systems. For example, the stored and collected PFAS contaminates collected in the foam layer of one process may then be run through the inlet of a further foam fractionation system having similar characteristics, structure, and conditions as those described in accordance with FIG. 1. In some embodiments, the concentrated PFAS entering a foam fractionation continuous, multistage system may enter the system and then a highly concentrated PFAS may be collected in the foam layer of that system. In some embodiments, once the PFAS is highly concentrated, the PFAS may then be sent to a device for permanent destruction. For example, the PFAS may be sent to a supercritical water oxidation method.

In some embodiments, the foam fractionation system of FIG. 2 may include different arrangements of foam fractionation columns that are tailored to specific requirements. In certain embodiments, the specific requirements are pre-determined.

In some embodiments, the specific requirements include, but are not limited to, the amount of wastewater to be processed, the flow at which the processing needs to be carried out, and a degree of PFAS concentration required.

There can be a variety of possible arrangements for the process, one embodiment of such process shown in FIG. 2. As shown in FIG. 2, eight foam fractionation columns can be used to treat the incoming water contaminated with PFAS and to convert it to clean water. As also shown in FIG. 2, the foam produced by these columns can be further treated in two groups of foam fractionation columns, for example with each consisting of four columns. In embodiments where there are large amounts of wastewater to be treated, the process may use additional columns connected in parallel.

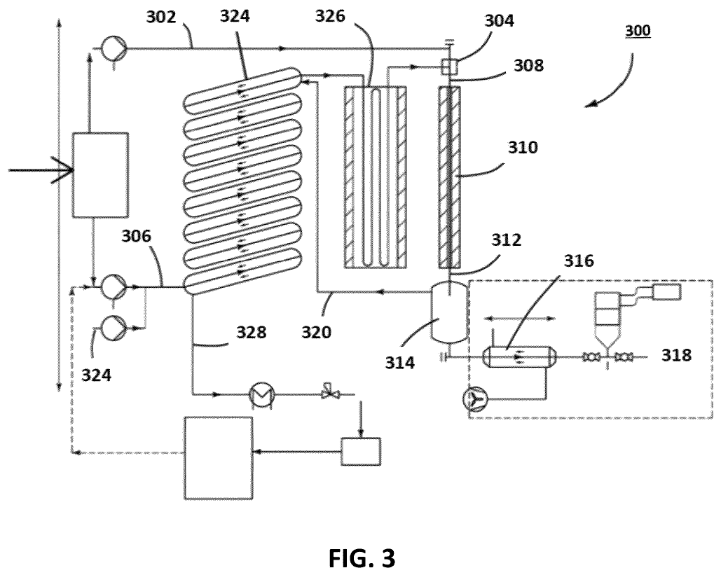

FIG. 3 depicts a supercritical water oxidation method for use in a process for removing and disposing of concentrated PFAS using a continuous foam fractionation system for use with water contaminated with PFAS, in accordance with certain embodiments of the present disclosure. The disclosure and teachings of U.S. Pat. No. 11,401,180 B2, entitled “Destruction of PFAS via an oxidation process and apparatus suitable for transportation to contaminated sites” are incorporated by reference in their entirety.

A preferred system 300 is illustrated in FIG. 3. In the embodiment of FIG. 3, PFAS-contaminants 302, as can be extracted by the system of FIGS. 1 and 2, enters mixing tee 304. In certain preferred embodiments, the PFAS-contaminants enters the tee at ambient conditions (room temperature) or relatively low temperature so that the inlet line is not corroded. In the mixing tee, the PFAS-contaminants 302 are mixed with hot, clean water 306, which may be, for example, 650° C. The combined stream can be at a combined temperature.

The oxidant 324 can be in either stream 302 or 306. In preferred embodiments, the oxidant 324 is in stream 306 to prevent premature reaction. Combined stream 308 passes into Supercritical Water Oxidation (SCWO) reactor 310. In some embodiments, the SCWO reactor 310 is a vertical tube, in respect to gravity, surrounded by insulation and heating means for start-up. Temperature in the SCWO reactor 310 in certain embodiments is in the range of 500 to 700° C.

The effluent 312 can passes into a salt separator 314 where salt can be removed manually or through exhaust system 316. In such an embodiment, the system is left as brine 318. Salt can be a mixture of sodium chloride, sodium fluoride, sodium sulfate, sodium nitrate or corresponding salts of other alkali or alkaline earth elements.

Fluid 320, in certain embodiments, leaves the separator and is routed through a heat exchanger 322, in the direction indicated such that temperature of fluid 320 is highest where the clean water 306 leaves the heat exchanger.

In some embodiments, after passing the heat exchanger, the clean water 306 may optionally be passed through heater 326 to heat the water to 600° C. or higher. After passing through the heat exchanger, effluent 328 can leave the system and optionally be neutralized at any point after exiting the SCWO reactor 310. In some embodiments, all or a portion of the effluent can also be recycled into the system and/or released into the environment or a water treatment facility.

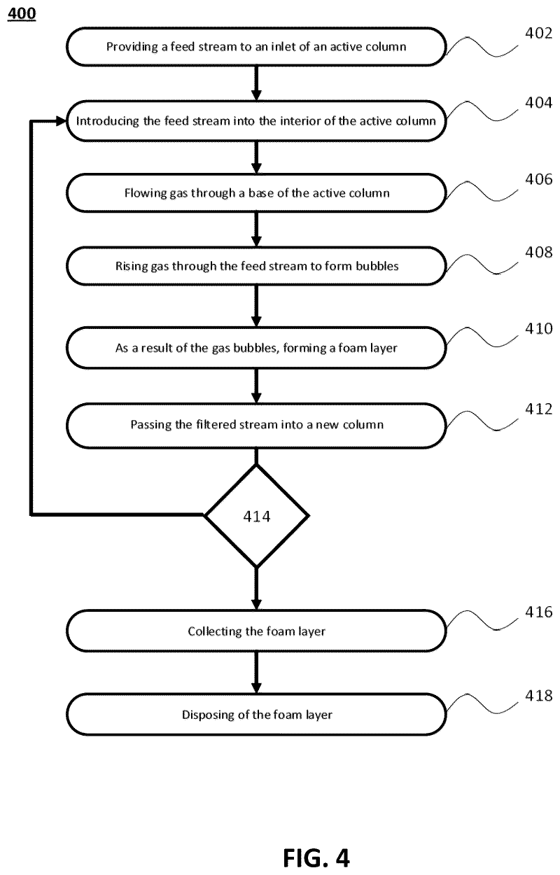

Referring to FIG. 4, which depicts a block diagram of a method for using a continuous foam fractionation system to treat water contaminated with PFAS, the method may be initiated by determining a water source containing contaminants. In certain preferred embodiments, a water source that has been contaminated with PFAS is identified. For example, in some embodiments, the water source may be contaminated with PFOS or PFOA, or combinations thereof. In some embodiments of the present disclosure, the method may be used to isolate and identify whether a suspected water source does in fact contain PFAS.

As shown in FIG. 4, method 400 beings at step 402. At step 402, the method includes providing a feed stream to an inlet of an active column. In some embodiments, the feed stream can include a PFAS contaminant. In some embodiments, the feed stream may predominately include water or an aqueous solution. In certain embodiments, the feed stream may include organic contaminants, inorganic contaminants, or combinations thereof. In certain embodiments, the feed stream may include one or more additives. For example, the feed stream can include additives allowing for the feed stream to be at a set pH. In another example, the feed stream can include additives that allow for the feed stream to have a particular ionic strength.

At step 404, the method includes introducing the feed stream into an interior of the active column. For example, in such an embodiment, the feed stream can be housed within a column for foam fractionation. At step 406, the method includes flowing gas through a base of the active column into the interior of the active column. In some embodiments, the gas may be introduced via a porous gas nozzle. In certain embodiments, the gas may be introduced via a venturi device where the compressed gas drives water flow, which in turn can mix the gas and water streams. In other embodiments, the gas may be introduced via a water vacuum pump device where water flow generates suction that introduces gas stream into a water stream. Moreover, in some embodiments, the gas can be introduced near an impeller, a mixer, or a combination thereof to generate gas-water mixing.

The gas, in certain embodiments, may be compressed air, oxygen, nitrogen, carbon dioxide, or combinations thereof. In some embodiments, the gas may be any gaseous phase chemical composition that will allow for contaminant adsorption on the surface of gas bubbles of the gas.

At step 408, the method includes, as a result of the flowing of the gas into the interior of the active column, rising gas through the feed stream in the interior of the active column to form gas bubbles in the feed stream.

At step 410, as a result of the gas bubbles in the feed stream, the method includes forming a foam layer. In some embodiments, the foam layer is situated atop the feed stream in the interior of the active column. In certain embodiments, the foam layer can include at least a part of the

PFAS contaminant that was initially present in the feed stream. After the foam layer is formed, in some embodiments, the interior of the active column can include both the foam layer and a purified stream, where the purified stream is the result of the PFAS contaminant being removed from the feed stream.

At step 412, the method includes passing the purified stream into a next column. In some embodiments, the next column operates as the active column and the purified stream operates as the feed stream.

Following, at decision block 414, the method progresses to determine whether the solution flowing through the system as the filtered stream contains a sufficiently low level of contaminant to result in a cleaned stream. In some embodiments, the decision block 414 determinations are decided prior to the construction of a system for conducting the method 400. In such an embodiment, the calculation of the quantity of PFAS contaminant removed at each column can be performed. In this embodiment, based on the calculation, the system is designed to contain the number of columns that will achieve a cleaned stream containing a sufficiently low level of contaminant. Such an embodiment will have a static number of columns that the feed stream and/or filtered stream will pass through in the system.

If the decision at block 414 is negative (i.e., the purified stream contains an amount of PFAS that may pose a health risk or is greater than a pre-determined amount of PFAS contaminant), then the method restarts at step 404.

If the decision at block 414 is affirmative (i.e., there is a sufficiently minimal amount of PFAS remaining in the purified stream such that the water in the stream does not pose either a health risk or is less than a pre-determined amount of PFAS contaminant), then the method continues to step 416. In some embodiments, as the number of columns in the system performing the method is predetermined, the decision at block 414 does not change the architecture of the system performing method 400.

At step 416, the method includes collecting the foam layer. At step 418, the method includes disposing of the foam layer. The removal and concentration of PFAS through foam fractionation, in preferred embodiments, can allow for target molecules to be selectively adsorbed at the air-liquid interface of bubbles. This process, using the method of FIG. 4, is highly effective for hydrophobic molecules and, therefore, highly suitable for treating long-chain (chain ≥7 atoms) PFAS.

In some embodiments, to aid in the ability to treat the more hydrophilic short-chain (chain ≤6 atoms) PFAS, the process involves the removal of short-chain PFAS by integrating integrate one or more process units dedicated to short-chain PFAS removal into the foam fractionation system of FIGS. 1-2.

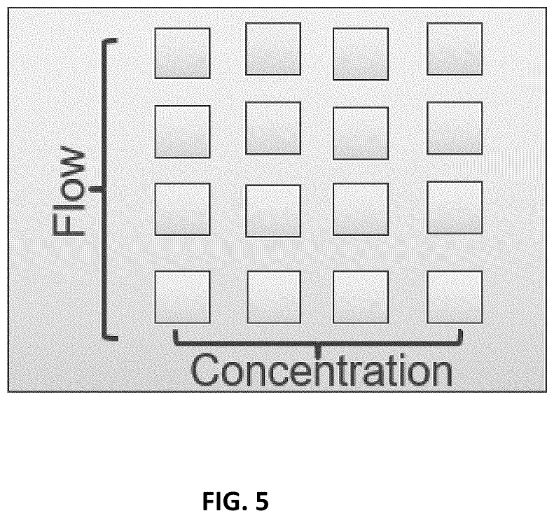

FIG. 5 depicts a diagram of a modular system that allows for flexibility in flow and concentration based on capabilities and needs of a system, in accordance with certain embodiments of the present disclosure.

As shown in FIG. 5, the foam fractionation process may be utilized in a flexible and modular system. For example, in some embodiments and as shown in FIG. 5, the system can be physically adjusted to meet specific pre-determined needs. Such flexibility allows for adjustment without the need for expensive redesign and rebuilding of an entire foam fractionation system.

The number of systems in parallel determines the total flow capacity, as shown in FIG. 5. Further, as shown in FIG. 5, the number of systems in series determines the total concentration.

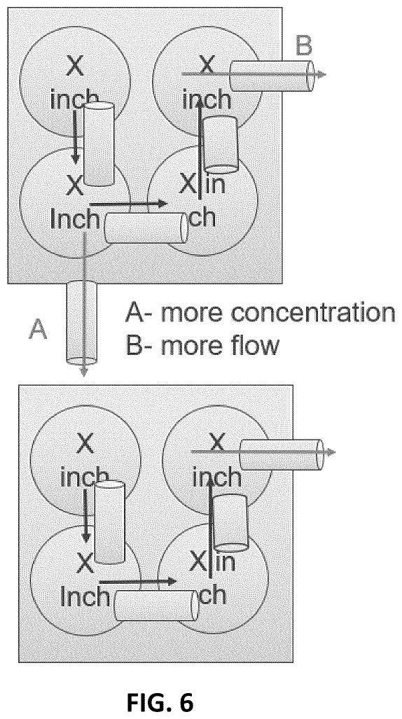

FIG. 6 depicts a diagram of a system that allows for flow routing using a plurality of inlet ports, in accordance with certain embodiments of the present disclosure.

In some embodiments, as shown in FIG. 6, the system can allow for the flow to be routed based on the use of a plurality of inlet ports, where the number of inlet ports utilized affects the flow. Further, as shown in FIG. 6, the system can allow for the concentration of the PFAS in the foam to be increased based on routing the flow from the flexible foam fractionation system through additional stages in the multistage process. Further, as shown FIG. 6, the use of multiple inlets B and the use of multi-stage connections. A through process columns with diameters X can allow for increased flow and increased concentration, respectively.

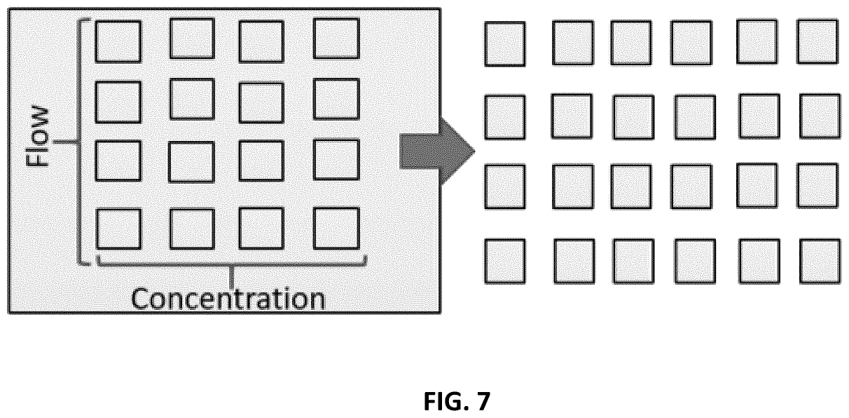

FIG. 7 depicts a diagram demonstrating the ability to increase concentration in system that allows for the modular components in a system flexible foam fractionation to be removed from a housing, in accordance with certain embodiments of the present disclosure.

In certain embodiments, the system can include modular components that may be freely movable, such that the modular components allow portions of the foam fractionation system to be taken out of a housing and expanded in number to increase flow or concentration as needed on site. In such an embodiment, the process can involve placing the foam fractionation columns on modular skids that can be fit into housings and taken out as needed. As shown by FIG. 7, removing the foam fractionation columns and portions of the system from a particular housing may allow for increased concentration.

In some embodiments, the system for foam fractionation can include a containerized system with external skids. Such a system could be deployed to increase either concentration or flow. Further, such an embodiment can be utilized to provide temporary increase in capability. In some embodiments, the system could be utilized to progressively increase the capacity of a system as need increases. Moreover, in some embodiments, the system may increase concentration where destruction is not available to save on storage space until destruction of the PFAS contaminants is available.

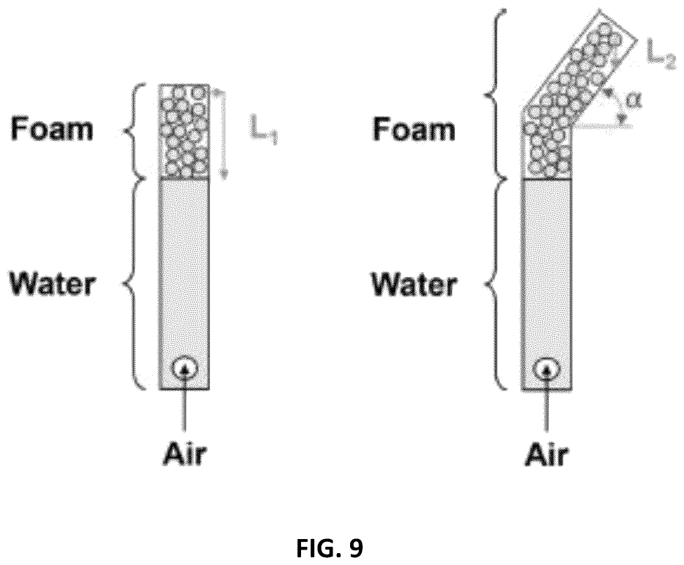

FIG. 9 depicts an angled foam fractionation column, in accordance with certain embodiments of the present disclosure.

As shown earlier in respect to FIG. 1, in some embodiments, the foam fractionation columns are vertical. In such embodiments, compressed air is injected into the liquid phase at the bottom of the column, which generates a foam that rises to the top. Further, in such embodiments, as the foam travels upward, extra water may travel with it leading to a wet foam (i.e., a foam that has retained a significant amount of water).

In some embodiments, to increase effective foam fractionation, the process can produce and utilize a relatively dry foam. A dry foam can increase the efficiency of the foam fractionation because the concentration of the target molecules in the foamate is maximized when the volume of water is minimized. Moreover, drainage from bubble breakage increases solute concentrations in the foam due to the elevated solute concentrations in liquid that originates from bubbles.

Accordingly, as shown in FIG. 9, in some embodiments, the foam fractionation system can include angling of the top portion of the foam fractionation columns. As shown in FIG. 9, when the top portion of the column is installed at an angle, α, the vertical distance a retained water molecule needs to travel to reach either the liquid phase or the wall of the column is decreased (L2<L1). In such an embodiment, this decrease facilitates the drainage of water from the foam, leading to more concentrated foamate. In certain embodiments, angle, α, is 45° as is shown in FIG. 9. This angle can be convenient to implement since pipe fittings facilitating 45° are commercially available.

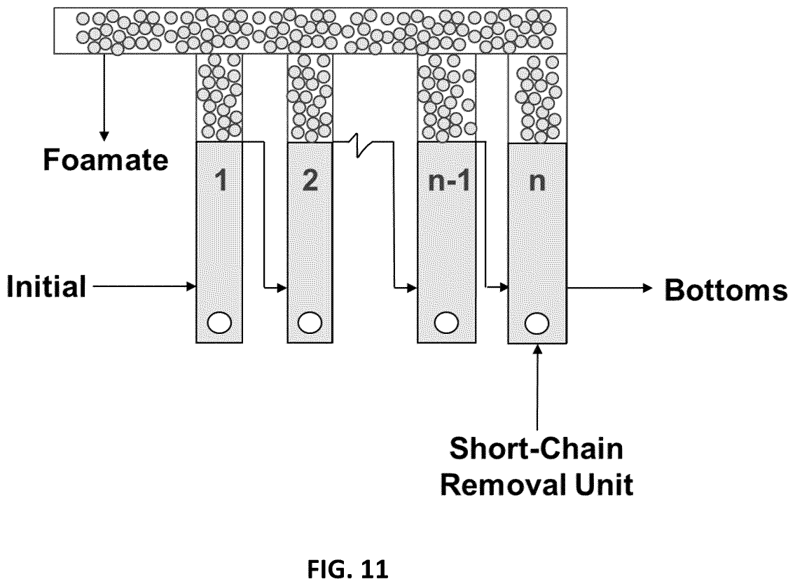

FIG. 11 depicts an illustration of a dedicated short chain removal unit within a foam fractionation system, in accordance with certain embodiments of the present disclosure.

As shown in FIG. 11, and explained earlier in respect to FIGS. 1-2, the system for foam fractionation can consist of multiple (n) columns that are connected to each other and allow for continuous foam fractionation of a contaminated stream. In some embodiments, as shown in FIG. 11, columns 1 through n-1 will focus on long-chain PFAS removal using the processes described in respect to FIGS. 1-2. In such an embodiment, the n^{th} column can be configured to target removal of the short-chain PFAS that remains after the processing in the prior columns of the system.

The removal of the short-chain PFAS may be performed, in some embodiments, by injecting a short-chain surfactant, β-cyclodextrin (β-CD) and/or its derivatives, powdered activated carbon (PAC), or a combination thereof into the column.

In some embodiments, the removal of short-chain PFAS using β-CD and/or its derivatives can be accomplished by injecting one or more β-CD derivatives into the final column in the foam fractionation system, by which point the majority of long-chain PFAS will have already been removed. In other embodiments, the one or more β-CD derivatives may be injected into a prior columns or multiple prior columns in the foam fractionation system.

In some embodiments, the removal of short-chain PFAS using PAC can be accomplished by injecting a slurry of PAC into one of the foam fractionation columns. In such an embodiment, to reduce the amount of PAC required, the slurry can be injected into the final column in the foam fractionation system, by which point the majority of long-chain PFAS will have already been removed. In other embodiments, the PAC may be injected into a prior columns or multiple prior columns in the foam fractionation system.

In some embodiments, the removal of the short-chain PFAS may be performed by incorporating a packed bed into the nth column. In certain embodiments, the packed bed may be made of granular activated carbon (GAC). In other embodiments, one or more β-CD derivatives could be incorporated into the packed bed.

In some embodiments, the foam fractionation system can include multiple process units. In such an embodiment, the number of process units implemented for short-chain PFAS removal may vary based on a variety of factors. For example, such factors can include but are not limited to the volume of the initial stream to be processed, the concentration of short-chain PFAS in the initial stream, and the efficiency of the short-chain removal method. Additionally, in certain embodiments, the processing units can have recycle streams that feed back into the long-chain PFAS removal unit.

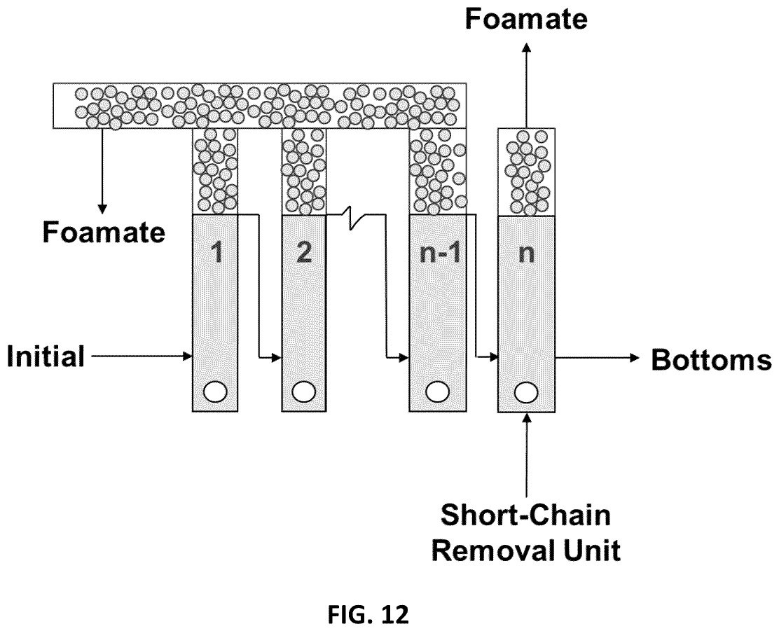

In other embodiments, the processing units may be entirely separate from the long-chain PFAS removal unit. FIG. 12 depicts an illustration of a dedicated short-chain PFAS removal unit separate from the long-chain PFAS removal units.

Consistent with the above disclosure, the examples of systems and methods enumerated in the following clauses are specifically contemplated and are intended as a non-limiting set of examples.

Clause 1. A method for using foam fractionation to remove a PFAS contaminant from a water source, the method includes providing a feed stream to an inlet of an active column, where the feed stream comprises the PFAS contaminant and water; introducing the feed stream into an interior of the active column; flowing gas through a base of the active column into the interior of the active column; as a result of the flowing of the gas into the interior of the active column, rising gas through the feed stream in the interior of the active column to form gas bubbles in the feed stream; as a result of the gas bubbles in the feed stream, forming a foam layer, wherein the foam layer is situated atop the feed stream in the interior of the active column, the foam layer comprises at least a part of the PFAS contaminant, and after the foam layer is formed, the interior of the active column comprises the foam layer and a purified stream; passing the purified stream into a next column, wherein the next column operates as the active column and the purified stream operates as the feed stream; continuously repeating foam fraction steps until the feed stream becomes a cleaned stream, wherein a cleaned stream comprises water and at or below a final concentration of the PFAS contaminant; collecting the foam layer; and disposing of the foam layer.

Clause 2. The method of any foregoing clause further including adding an effective amount of a surfactant to the feed stream.

Clause 3. The method of any foregoing clause further comprising, after collecting the foam layer, utilizing the foam layer as the feed stream.

Clause 4. The method of any foregoing clause further including interacting the surfactant the PFAS contaminant to create a complexing agent, where the foam layer comprises the complexing agent.

Clause 5. The method of any foregoing clause, where the PFAS contaminant in the feed stream has an initial PFAS concentration, the at least a part of the PFAS contaminant in the foam layer has removed PFAS concentration, and a remaining PFAS contaminant in the cleaned stream has a final PFAS concentration.

Clause 6. The method of any foregoing clause, where the initial PFAS concentration is equal to that of the removed PFAS concentration added to the final PFAS concentration, and where the removed PFAS concentration is greater than or equal to the final PFAS concentration.

Clause 7. The method of any foregoing clause, where the foam fractionation is continuous.

Clause 8. The method of any foregoing clause, where disposing of the foam layer comprises sending the foam layer to a supercritical water oxidation reactor.

Clause 9. The method of any foregoing clause further including releasing the cleaned stream into an environment.

Clause 10. A system for using foam fractionation to remove a PFAS contaminant from a water source, the system including a feed stream comprising water and one or more contaminants; a gas, where the gas is operable to induce a plurality of bubbles to form in the feed stream, and create a foam layer to form at and above the interface of the feed stream, where the foam layer comprises the one or more contaminants in the feed stream; and a plurality of columns, where each column in the plurality of columns comprises a feed inlet, wherein the feed inlet is configured to receive the feed stream, each column in the plurality of columns is operably configured to separate the one or more contaminants in the feed stream into a foam layer and a purified stream, each column in the plurality of columns comprises a gas inlet, wherein the gas inlet is configured to allow the gas to enter the column, each column in the plurality of the columns comprises a foam outlet, each column in the plurality of the columns comprises a feed outlet, wherein the feed outlet is configured to discharge the purified stream, and each column in the plurality of the columns is coupled to one or more other column in the plurality of the columns to allow a continuous passage of the feed stream through the plurality of columns.

Clause 11. The system of any foregoing clause, where the one or more contaminants comprise PFAS.

Clause 12. The system of any foregoing clause, where the foam outlet is operatively connected to a foam storage tank.

Clause 13. The system of any foregoing clause, where the foam storage tank is operatively connected to a device for destroying the one or more contaminants.

Clause 14. The system of any foregoing clause further comprising a supercritical water oxidation reactor.

Clause 15. The system of any foregoing clause further comprising a removal device for removing at least a portion of the foam layer from each column in the plurality of columns.

Clause 16. The system of any foregoing clause, where the feed inlet is configured to introduce the feed stream into each column in the plurality of columns through an upper region of each column in the plurality of columns.

Clause 17. The system of any foregoing clause, where the feed outlet is configured to introduce the discharge stream into each column in the plurality of columns through a lower region of each column in the plurality of columns.

Clause 18. A method for using foam fractionation to remove a PFAS contaminant from a water source, the method including selecting a feed stream, where the feed stream comprises the PFAS contaminant and water; providing the feed stream to a column, where the column is operatively connected to a series of fractionation columns, the series of fractionation columns perform continuous foam fractionation, and the column and each fractionation column in the series of fractionation columns operate at an operating pressure, where the operating pressure is identical between the column and each fractionation column in the series of fractionation columns; super-saturating the feed stream with air; resultant from the operating pressure of the column, generating a plurality of bubbles in the feed stream; resultant from the generating of a plurality of bubbles, creating a foam layer; collecting the foam layer; and passing the foam layer through a supercritical water oxidation reactor.

Clause 19. The method of any foregoing clause further comprising adding an effective amount of a surfactant to the feed stream.

Clause 20. The system of any foregoing clause further comprising, after collecting the foam layer, discharging a cleaned stream from a final column in the series of fractionation columns.

Clause 21. The system of any foregoing clause, where the PFAS contaminant in the feed stream has an initial PFAS concentration, the foam layer has a removed PFAS concentration, and the cleaned stream has a final PFAS concentration.

Clause 22. The system of any foregoing clause, where the initial PFAS concentration is equal to that of the removed PFAS concentration added to the final PFAS concentration, and where the removed PFAS concentration is greater than or equal to the final PFAS concentration.

Clause 23. The method of any foregoing clause further comprising releasing the cleaned stream into an environment.

Clause 24. A flexible and modular system for utilizing foam fractionation to remove a PFAS contaminant from a water source, the system including a feed stream including water and one or more contaminants; a gas, operable to induce a plurality of bubbles to form in the feed stream, and create a foam layer at and above the interface of the feed stream, where the foam layer includes the one or more contaminants in the feed stream; a plurality of foam fractionation columns, where each column in the plurality of columns includes a feed inlet, configured to receive the feed stream, each column is operably configured to separate the one or more contaminants in the feed stream into a foam layer and a purified stream, each column includes a gas inlet, configured to allow the gas to enter the column, each column includes a foam outlet, each column includes a feed outlet, configured to discharge the purified stream, each column is coupled to one or more other columns to allow a continuous passage of the feed stream through the plurality of columns, and the system is configurable in a variety of arrangements; a plurality of inlet ports, where the system allows for the flow to be routed based on the use of the plurality of inlet ports; and a plurality of modular components, where the plurality of modular components are configured to be removed from a housing to allow for increased concentration.

Clause 25. The system of any foregoing clause, where one or more foam fractionation columns in the plurality of foam fractionation columns are connected in parallel.

Clause 26. The system of any foregoing clause, where the plurality of foam fractionation columns include a number of foam fractionation systems, where the number of foam fractionation systems are physically adjustable to meet a pre-determined need.

Clause 27. The system of any foregoing clause, where the plurality of foam fractionation columns includes a number of foam fractionation systems, where a width established by the number of foam fractionation systems determines the total flow capacity.

Clause 28. The system of any foregoing clause, where the plurality of foam fractionation columns includes a number of foam fractionation systems, where the number of foam fractionation systems in series determines the total degree of water purification.

Clause 28. The system of any foregoing clause, where the plurality inlet ports are configured to affect the flow and increase concentration of the one or more contaminants in the foam layer.

Clause 30. The system of any foregoing clause, where the plurality of foam fractionation columns are oriented to route the flow through additional stages in the multistage process, where the routing allows for increased flow and increased concentration.

Clause 31. The system of any foregoing clause, where the modular components are freely movable.

Clause 32. The system of any foregoing clause, where the modular components allow for one or more foam fractionation columns in the plurality of foam fractionation columns to be taken out of a housing.

Clause 33. The system of any foregoing clause, where the modular components are operatively configured to be received by skids that fit into containers, where the skids are removable from the containers.

Clause 34. The system of any foregoing clause, where removing the foam fractionation columns and portions of the system from a housing allows for increased concentration.

Clause 35. The system of any foregoing clause, further including a containerized system with external skids.

Clause 36. The system of any foregoing clause, where the containerized system with external skids are configured to be deployed to increase either concentration or flow.

Clause 37. The system of any foregoing clause, where the containerized system provides a temporary increase in capability.

Clause 38. The system of any foregoing clause, where the containerized system progressively increases the capacity as need increases.

Clause 39. An angled foam fractionation column for removing one or more PFAS contaminants from a water source, the column comprising: a feed inlet configured to receive a feed stream comprising water, one or more PFAS contaminants, and an effective amount of a surfactant, wherein the surfactant interacts with the PFAS contaminant to form a complexing agent facilitating the removal of light PFAS; a gas inlet configured to allow the entry of a gas operable to induce a plurality of bubbles in the feed stream and create a foam layer at and above the interface of the feed stream, wherein the foam layer comprises the complexing agent and the one or more contaminants; a foam outlet for discharging the foam layer; a feed outlet configured to discharge a purified stream; and a top portion angled at an angle (α) with respect to the vertical axis of the column, wherein the angled top portion decreases the vertical distance a retained water molecule needs to travel, facilitating the drainage of water from the foam and resulting in a more concentrated foamate.

Clause 40. The angled foam fractionation column of any foregoing clause, where the angle (α) of the top portion is approximately 45 degrees to optimize the drainage of water from the foam.

Clause 41. The angled foam fractionation column of any foregoing clause, where the angling of the top portion results in minimizing the volume of water retained in the foam, thereby producing a relatively dry foam.

Clause 42. The angled foam fractionation column of any foregoing clause, where the production of a relatively dry foam increases the concentration of the target PFAS contaminants in the foamate.

Clause 43. The angled foam fractionation column of any foregoing clause, where the increased concentration of PFAS contaminants in the foamate is facilitated by the elevated solute concentrations in the liquid that originates from bubble breakage.

Clause 44. The angled foam fractionation column of any foregoing clause further including a mechanism for injecting compressed air into the liquid phase at the bottom of the column to generate foam.

Clause 45. The angled foam fractionation column of any foregoing clause, where the compressed air induces a plurality of bubbles in the feed stream, creating a foam layer at and above the interface of the feed stream.

Clause 46. The angled foam fractionation column of any foregoing clause, where the foam layer comprises a complexing agent formed by the interaction of the surfactant and the one or more PFAS contaminants, facilitating the removal of light PFAS.

Clause 47. The angled foam fractionation column of any foregoing clause, where the decreased vertical distance a retained water molecule needs to travel due to the angled top portion facilitates the drainage of water, leading to a more concentrated foamate.

Clause 48. The angled foam fractionation column of any foregoing clause, where the column is part of a system comprising a plurality of such columns, each coupled to one or more other columns allowing continuous passage of the feed stream and comprising ports for surfactant addition located throughout various columns to optimize the volume of foam produced in each stage and ensure sufficient surfactant presence.

Clause 49. A system for using foam fractionation to remove a PFAS contaminant from a water source, the system comprising a feed stream comprising water, one or more PFAS contaminants, and an effective amount of a surfactant, wherein the surfactant interacts with the PFAS contaminant to form a complexing agent facilitating the removal of light PFAS; a gas, operable to induce a plurality of bubbles in the feed stream and create a foam layer at and above the interface of the feed stream, wherein the foam layer comprises the complexing agent and the one or more contaminants; a plurality of columns, wherein each column comprises a feed inlet configured to receive the feed stream and a gas inlet configured to allow the gas to enter, each column is operably configured to separate the contaminants into a foam layer and a purified stream, each column comprises a foam outlet and a feed outlet configured to discharge the purified stream, each column is coupled to one or more other columns allowing continuous passage of the feed stream, the plurality of columns comprise a plurality of ports for surfactant addition, wherein the plurality of ports are located throughout various columns in the plurality of columns to optimize the volume of foam produced in each stage and ensure sufficient surfactant presence, and the plurality of ports for adding surfactants are installed in a configuration enabling the addition of surfactants at different columns, such as every other column.

Clause 50. The system of any foregoing clause, where the system is adaptable to incorporate different surfactant amounts and/or types at different points, enabling the addition of more columns for enhanced separation.

Clause 51. The system of any foregoing clause, where at least one column in the plurality of columns comprises an angled top portion, where the angled top portion is disposed at an angle (α) with respect to the vertical axis of the column, facilitating the drainage of water from the foam and resulting in a more concentrated foamate; the decrease in vertical distance a retained water molecule needs to travel due to the angled top portion enhances the efficiency of foam fractionation by maximizing the concentration of target molecules in the foamate; and the angle (α) is configured to minimize the volume of retained water in the foam, thereby producing a relatively dry foam and increasing solute concentrations in the foamate from the drainage of bubble breakage; and

Clause 52. The system of any foregoing clause, wherein the angle (α) is approximately 45 degrees.

Clause 53. A method for using foam fractionation to remove a PFAS contaminant from a water source, the method comprising: providing a feed stream to an inlet of an active column, wherein the feed stream comprises the PFAS contaminant and water; introducing the feed stream into an interior of the active column; flowing gas through an active column into the interior of the active column; as a result of the flowing of the gas into the interior of the active column, rising gas through the feed stream in the interior of the active column to form gas bubbles in the feed stream; as a result of the gas bubbles in the feed stream, forming a foam layer, wherein the foam layer is situated atop the feed stream in the interior of the active column, the foam layer comprises at least a part of the PFAS contaminant, and after the foam layer is formed, the interior of the active column comprises the foam layer and a purified stream; in instances where insufficient foam is generated due to depletion of surfactant in the earlier columns, adding additional surfactant through ports located in various columns throughout the system to ensure the presence of sufficient surfactant in all columns and optimize the volume of foam produced in each stage; passing the purified stream into a next column, wherein the next column operates as the active column and the purified stream operates as the feed stream; continuously repeating steps (b) through (f) until the feed stream becomes a cleaned stream, wherein a cleaned stream comprises water and at or below a final concentration of the PFAS contaminant; collecting the foam layer; and disposing of the foam layer.

Clause 54. The method of any foregoing clause, where the feed stream includes an effective amount of a surfactant added therein.

Clause 55. The method of any foregoing clause, where the surfactant interacts with the PFAS contaminant to create a complexing agent.

Clause 56. The method of any foregoing clause, where the complexing agent facilitates the removal of light PFAS from the contaminated water source.

Clause 57. The method of any foregoing clause, where the surfactant is introduced prior to the feed stream entering the column.

Clause 58. The method of any foregoing clause, where the surfactant is introduced to a purified stream in a series of active columns.

Clause 59. The method of any foregoing clause further including multiple surfactant addition points, where the surfactants are added to the feed stream, the purified stream, or combinations thereof.

Clause 60. The method of any foregoing clause, where the ports for adding additional surfactant are installed into every other column in the foam fractionation system.

Clause 61. The method of any foregoing clause, where different surfactant amounts and/or types are injected at different points in the system.

Clause 62. The method of any foregoing clause, where the addition of surfactants at the ports optimizes the volume of foam produced in each stage.

Clause 63. A system for using foam fractionation to remove a PFAS contaminant from a water source, the system comprising: a feed stream comprising water, one or more PFAS contaminants, and an effective amount of a surfactant, wherein the surfactant interacts with the PFAS contaminant to form a complexing agent facilitating the removal of light PFAS; a gas, operable to induce a plurality of bubbles in the feed stream and create a foam layer at and above the interface of the feed stream, wherein the foam layer comprises the complexing agent and the one or more contaminants; a plurality of columns, wherein each column comprises a feed inlet configured to receive the feed stream and a gas inlet configured to allow the gas to enter, each column is operably configured to separate the contaminants into a foam layer and a purified stream, each column comprises a foam outlet and a feed outlet configured to discharge the purified stream, each column is coupled to one or more other columns allowing continuous passage of the feed stream, the plurality of columns comprise a plurality of ports for surfactant addition, wherein the plurality of ports are located throughout various columns in the plurality of columns to optimize the volume of foam produced in each stage and ensure sufficient surfactant presence, the plurality of ports for adding surfactants are installed in a configuration enabling the addition of surfactants at different columns, such as every other column.

Clause 64. The system of any foregoing clause, where the system is adaptable to incorporate different surfactant amounts and/or types at different points, enabling the addition of more columns for enhanced separation.

Clause 65. A method for using foam fractionation to remove both long-chain and short-chain PFAS contaminants from a water source, the method including providing a feed stream to an inlet of an active column, where the feed stream comprises a long-chain PFAS contaminant, a short-chain PFAS contaminant, and water; introducing the feed stream into an interior of the active column; flowing gas through an active column into the interior of the active column; as a result of the flowing of the gas into the interior of the active column, rising gas through the feed stream in the interior of the active column to form gas bubbles in the feed stream; as a result of the gas bubbles in the feed stream, forming a foam layer, the foam layer is situated atop the feed stream in the interior of the active column, the foam layer comprises the long-chain PFAS contaminant, after the foam layer is formed, the interior of the active column comprises the foam layer and a remaining stream, where the remaining stream comprises short-chain PFAS and water; configuring a next column for targeted removal of short-chain PFAS, where the next column comprises a short-chain process unit; passing the remaining stream into the next column, where the next column is configured to remove the short-chain PFAS in the remaining stream, after the removal of the short-chain PFAS from the remaining stream, the interior of the next column includes a purified stream; collecting the foam layer; disposing of the foam layer.

Clause 66. The method of any foregoing clause, where the short-chain process unit in the next column utilizes a short-chain surfactant to aid in the removal of short-chain PFAS.

Clause 67. The method of any foregoing clause, where the short-chain surfactant comprises β-cyclodextrin (β-CD) or its derivatives.

Clause 68. The method of any foregoing clause, where the β-cyclodextrin or its derivatives are injected into the final column of the foam fractionation system.

Clause 69. The method of any foregoing clause, where the short-chain process unit in the next column utilizes powdered activated carbon (PAC) for the removal of short-chain PFAS.

Clause 70. The method of any foregoing clause, where the PAC is introduced as a slurry into the final column of the foam fractionation system to optimize the amount of PAC used.

Clause 71. The method of any foregoing clause further including incorporating a packed bed into the next column for the removal of short-chain PFAS.

Clause 72. The method of any foregoing clause, where the packed bed is comprised of granular activated carbon (GAC).

Clause 73. The method of any foregoing clause, where the packed bed incorporates one or more ß-cyclodextrin derivatives.

Clause 74. The method of any foregoing clause, where the foam fractionation system comprises multiple connected columns allowing for continuous foam fractionation.

Clause 75. The method of any foregoing clause, where a total number of short-chain process units is determined based on factors including the volume of the initial stream, the concentration of short-chain PFAS, and the efficiency of the short-chain removal method.

Clause 76. The method of any foregoing clause further including implementing recycle streams in the processing units that feed back into the long-chain PFAS removal unit.

Clause 77. The method of any foregoing clause, where the processing units for short-chain PFAS removal are separate from the long-chain PFAS removal unit.

Clause 78. The method of any foregoing clause, where the foam layer collected comprises primarily the long-chain PFAS contaminant.

Clause 79. A system for using foam fractionation to remove both long-chain and short-chain PFAS contaminants from a water source, the system including a feed stream including water, a long-chain PFAS contaminant, and a short-chain PFAS contaminant; a gas, operable to induce a plurality of bubbles to form in the feed stream, enable selective adsorption of the long-chain PFAS contaminants at the air-liquid interface of the bubbles to form a foam layer at and above the interface of the feed stream, wherein the foam layer primarily comprises long-chain PFAS contaminants; a plurality of columns connected for continuous foam fractionation, wherein: each column comprises a feed inlet configured to receive the feed stream, each column is operably configured to separate the long-chain PFAS contaminants in the feed stream into a foam layer and a remaining stream comprising short-chain PFAS and water, each column comprises a gas inlet configured to allow the gas to enter the column, each column comprises a foam outlet, each column comprises a feed outlet configured to discharge the remaining stream, and a final column in the plurality of columns is configured with a short-chain PFAS removal unit configured for targeted removal of short-chain PFAS from the remaining stream.

Clause 80. The system of any foregoing clause, where the short-chain PFAS removal unit is configured to inject β-cyclodextrin (β-CD) and/or its derivatives for the targeted removal of short-chain PFAS contaminants.

Clause 81. The system of any foregoing clause, where the short-chain PFAS removal unit is configured to inject powdered activated carbon (PAC) for the targeted removal of short-chain PFAS contaminants.

Clause 82. The system of any foregoing clause, where the final column comprises a packed bed for removal of short-chain PFAS contaminants.

Clause 83. The system of any foregoing clause, where the packed bed is made of granular activated carbon (GAC).

Clause 84. The system of any foregoing clause, where the packed bed is made of β-cyclodextrin (β-CD) derivatives.

Clause 85. The system of any foregoing clause, where the configuration of each column in the plurality of columns and the short-chain PFAS removal unit are determined based on one or more factors selected from the group consisting of: the volume of the initial stream, the concentration of short-chain PFAS, and the efficiency of the short-chain removal method.

Clause 86. The system of any foregoing clause, where the short-chain PFAS removal unit incorporated within the columns dedicated for long-chain PFAS removal.

Clause 87. The system of any foregoing clause, where the short-chain PFAS removal unit is separate from the columns dedicated for long-chain PFAS removal.

Clause 88. The system of any foregoing clause further comprising a means for collecting and disposing of the foam layer comprising long-chain PFAS contaminants.

Clause 89. The system of any foregoing clause further comprising a means for discharging a purified stream from the nth column after the removal of both long-chain and short-chain PFAS contaminants.

What is claimed is:

1. A method for using foam fractionation to remove a PFAS contaminant from a water source, the method comprising:
(a) providing a feed stream to an inlet of an active column, wherein the feed stream comprises the PFAS contaminant and water;
(b) introducing the feed stream into an interior of the active column;
(c) flowing gas through an active column into the interior of the active column;
(d) as a result of the flowing of the gas into the interior of the active column, rising gas through the feed stream in the interior of the active column to form gas bubbles in the feed stream;
(e) as a result of the gas bubbles in the feed stream, forming a foam layer, wherein
(i) the foam layer is situated atop the feed stream in the interior of the active column,
(ii) the foam layer comprises at least a part of the PFAS contaminant, and
(iii) after the foam layer is formed, the interior of the active column comprises the foam layer and a purified stream;
(f) in instances where insufficient foam is generated due to depletion of surfactant in the earlier columns, adding additional surfactant or surfactants through ports located in various columns throughout the system to ensure the presence of sufficient surfactant in all columns and optimize the volume of foam produced in each stage;
(g) passing the purified stream into a next column, wherein the next column operates as the active column and the purified stream operates as the feed stream;
(h) continuously repeating steps (b) through (f) until the feed stream becomes a cleaned stream, wherein a cleaned stream comprises water and at or below a final concentration of the PFAS contaminant;
(i) collecting the foam layer; and
(j) disposing of the foam layer.

2. The method of claim 1, wherein the feed stream includes an effective amount of a surfactant or surfactants added therein.

3. The method of claim 2, wherein the surfactant interacts with the PFAS contaminant to create a complexing agent.

4. The method of claim 3, wherein the complexing agent facilitates the removal of light PFAS from the contaminated water source.

5. The method of claim 2, wherein the surfactant is introduced prior to the feed stream entering the column.

6. The method of claim 2, wherein the surfactant is introduced to a purified stream in a series of active columns.

7. The method of claim 1, further comprising multiple surfactant addition points, where the surfactants are added to the feed stream, the purified stream, or combinations thereof.

8. The method of claim 1, wherein the ports for adding additional surfactant are installed into every other column in the foam fractionation system.

9. The method of claim 1, wherein different surfactant amounts and/or types are injected at different points in the system.

10. The method of claim 1, wherein the addition of surfactants at the ports optimizes the volume of foam produced in each stage.

11. A system for using foam fractionation to remove a PFAS contaminant from a water source, the system comprising:
(a) a feed stream comprising water, one or more PFAS contaminants, and an effective amount of a surfactant, wherein the surfactant interacts with the PFAS contaminant to form a complexing agent facilitating the removal of light PFAS;
(b) a gas, operable to induce a plurality of bubbles in the feed stream and create a foam layer at and above the interface of the feed stream, wherein the foam layer comprises the complexing agent and the one or more contaminants;
(c) a plurality of columns, wherein:
(i) each column comprises a feed inlet configured to receive the feed stream and a gas inlet configured to allow the gas to enter,
(ii) each column is operably configured to separate the contaminants into a foam layer and a purified stream,
(iii) each column comprises a foam outlet and a feed outlet configured to discharge the purified stream,
(iv) each column is coupled to one or more other columns allowing continuous passage of the feed stream,
(v) the plurality of columns comprise a plurality of ports for surfactant addition, wherein the plurality of ports are located throughout various columns in the plurality of columns to optimize the volume of foam produced in each stage and ensure sufficient surfactant presence, and
(vi) the plurality of ports for adding surfactants are installed in a configuration enabling the addition of surfactants at different columns, such as every other column.

12. The system of claim 11, wherein the system is adaptable to incorporate different surfactant amounts and/or types at different points, enabling the addition of more columns for enhanced separation.

13. A method for using foam fractionation to remove both long-chain and short-chain PFAS contaminants from a water source, the method comprising:
(a) providing a feed stream to an inlet of an active column, wherein the feed stream comprises a long-chain PFAS contaminant, a short-chain PFAS contaminant, and water;
(b) introducing the feed stream into an interior of the active column;
(c) flowing gas through an active column into the interior of the active column;
(d) as a result of the flowing of the gas into the interior of the active column, rising gas through the feed stream in the interior of the active column to form gas bubbles in the feed stream;
(e) as a result of the gas bubbles in the feed stream, forming a foam layer, wherein
(i) the foam layer is situated atop the feed stream in the interior of the active column,
(ii) the foam layer comprises the long-chain PFAS contaminant, and
(iii) after the foam layer is formed, the interior of the active column comprises the foam layer and a remaining stream, wherein the remaining stream comprises short-chain PFAS and water;
(f) configuring a next column for targeted removal of short-chain PFAS, wherein the next column comprises a short-chain process unit;
(g) passing the remaining stream into the next column, wherein
(i) the next column is configured to remove the short-chain PFAS in the remaining stream, and
(ii) after the removal of the short-chain PFAS from the remaining stream, the interior of the next column comprises a purified stream;
(h) collecting the foam layer; and
(i) disposing of the foam layer.

14. The method of claim 13, wherein the short-chain process unit in the next column utilizes a short-chain surfactant to aid in the removal of short-chain PFAS.

15. The method of claim 14, wherein the short-chain surfactant comprises β-cyclodextrin (β-CD) or its derivatives.

16. The method of claim 15, wherein the β-cyclodextrin or its derivatives are injected into one or more of final columns of the foam fractionation system.

17. The method of claim 13, wherein the short-chain process unit in the next column utilizes powdered activated carbon (PAC) for the removal of short-chain PFAS.

18. The method of claim 17, wherein the PAC is introduced as a slurry into one or more of the final columns of the foam fractionation system to optimize the amount of PAC used.

19. The method of claim 13, further comprising incorporating a packed bed into the next column for the removal of short-chain PFAS.

20. The method of claim 19, wherein the packed bed is comprised of granular activated carbon (GAC).

21. The method of claim 19, wherein the packed bed incorporates one or more β-cyclodextrin derivatives.

22. The method of claim 13, wherein the foam fractionation system comprises multiple connected columns allowing for continuous foam fractionation.

23. The method of claim 13, wherein a total number of short-chain process units is determined based on factors including the volume of the initial stream, the concentration of short-chain PFAS, and the efficiency of the short-chain removal method.

24. The method of claim 13 further comprising implementing recycle streams in the processing units that feed back into the long-chain PFAS removal unit.

25. The method of claim 13, wherein the processing units for short-chain PFAS removal are separate from the long-chain PFAS removal unit.

26. The method of claim 13, wherein the foam layer collected comprises primarily the long-chain PFAS contaminant.

27. A system for using foam fractionation to remove both long-chain and short-chain PFAS contaminants from a water source, the system comprising:
(a) a feed stream comprising water, a long-chain PFAS contaminant, and a short-chain PFAS contaminant;
(b) a gas, operable to:
(i) induce a plurality of bubbles to form in the feed stream,
(ii) enable selective adsorption of the long-chain PFAS contaminants at the air-liquid interface of the bubbles to form a foam layer at and above the interface of the feed stream, wherein the foam layer primarily comprises long-chain PFAS contaminants;
(c) a plurality of columns connected for continuous foam fractionation, wherein:
(i) each column comprises a feed inlet configured to receive the feed stream,
(ii) each column is operably configured to separate the long-chain PFAS contaminants in the feed stream into a foam layer and a remaining stream comprising short-chain PFAS and water,
(iii) each column comprises a gas inlet configured to allow the gas to enter the column,
(iv) each column comprises a foam outlet,
(v) each column comprises a feed outlet configured to discharge the remaining stream, and
(vi) a final column in the plurality of columns is configured with a short-chain PFAS removal unit configured for targeted removal of short-chain PFAS from the remaining stream.

28. The system of claim 27, wherein the short-chain PFAS removal unit is configured to inject β-cyclodextrin (β-CD) and/or its derivatives for the targeted removal of short-chain PFAS contaminants.

29. The system of claim 27, wherein the short-chain PFAS removal unit is configured to inject powdered activated carbon (PAC) for the targeted removal of short-chain PFAS contaminants.

30. The system of claim 27, wherein the final column comprises a packed bed for removal of short-chain PFAS contaminants.

30. system of claim 30, wherein the packed bed is made of granular activated carbon (GAC).

32. The system of claim 30, wherein the packed bed is made of β-cyclodextrin (β-CD) derivatives.

33. The system of claim 27, wherein the configuration of each column in the plurality of columns and the short-chain PFAS removal unit are determined based on one or more factors selected from the group consisting of: the volume of the initial stream, the concentration of short-chain PFAS, and the efficiency of the short-chain removal method.

34. The system of claim 27, wherein the short-chain PFAS removal unit incorporated within the columns dedicated for long-chain PFAS removal.

35. The system of claim 27, wherein the short-chain PFAS removal unit is separate from the columns dedicated for long-chain PFAS removal.

36. The system of claim 27, further comprising a means for collecting and disposing of the foam layer comprising long-chain PFAS contaminants.

37. The system of claim 27, further comprising a means for discharging a purified stream from the nth column after the removal of both long-chain and short-chain PFAS contaminants.
